(19) United States
(12) Patent Application Publication
(10) Pub. No.: US 2018/0343998 A1
(43) Pub. Date: Dec. 6, 2018

(54) HAIR CARE PRODUCT AND METHOD FOR APPLYING A HAIR CARE PRODUCT OF THIS TYPE

(71) Applicant: Henkel AG & Co. KGaA, Duesseldorf (DE)

(72) Inventors: Louise Hogan, Hamburg (DE); Erik Schulze zur Wiesche, Hamburg (DE)

(73) Assignee: Henkel AG & Co. KGaA, Duesseldorf (DE)

(21) Appl. No.: 16/058,359

(22) Filed: Aug. 8, 2018

Related U.S. Application Data
(63) Continuation of application No. PCT/EP2016/080867, filed on Dec. 14, 2016.

(30) Foreign Application Priority Data
Feb. 10, 2016 (DE) 102016201995.3
Apr. 7, 2016 (DE) 102016205825.8

(51) Int. Cl. A45D 19/00; B44D 3/02

(52) U.S. Cl. CPC A45D 19/0008; A45D 2007/001; A45D 2019/0091; B44D 3/02

(57) ABSTRACT

A product for dyeing hair, and an associated method for applying such a hair dye product. The hair dye product of this type allows multiple hair dye preparations to be used simultaneously on the hair. The hair care product includes a plurality of hair dye preparations for application to the hair, as well as a tray for receiving a plurality of hair dye preparations, the tray having at least two depressions that are separated from one another by a separating wall so as to supply one hair dye preparation in each depression for application.

### FIELD OF THE INVENTION

The invention relates to a product for hair coloring treatment, and to an associated method for applying a hair coloring product of this kind. In this case, the generic hair coloring product makes it possible to use a plurality of hair coloring preparations on the hair simultaneously.

### BACKGROUND OF THE INVENTION

Applying conventional hair treatment products for coloring hair is usually very time-consuming and very often requires a multistage procedure. For example, WO 2004/041020 A2 describes a kit-type system for color-changing hair treatment which comprises, in addition to a bleach component, a further color-imparting hair treatment component. The main aim of this hair treatment system is to achieve a multi-tonal hair coloring result. For this purpose, however, it is necessary for a plurality of individual system components to be provided for said hair treatment system and, as mentioned, for multiple hair treatment steps to be carried out. In particular, for a multi-tonal hair coloring result, the hair is first treated with bleach in order to then create hair strands that have a different tone by means of a color-imparting hair coloring preparation. This type of hair treatment is undesirably complex on account of not only the equipment used, but also the amount of time required.

Furthermore, WO 2015/177577 A1 discloses a device and an associated method for creating a three-dimensional and/or multicolored pattern on the hair in just one working step. For this purpose, the hair strand to be treated is put into a device similar to a printing press. This device similar to a printing press has an upper part and a lower part and, owing to the design of said upper and lower part, gives the treated hair strand a specific three-dimensional structure, for example, which also stays in the hair. The hair can also be covered with multiple shades, and therefore hair can additionally be “printed” with various tones. The described device is very expensive and is only used for a specific design in each case. The possible uses are therefore very limited.

US 2015/0359310 A1 also discloses an application system for treating hair with multiple colors in just one working step, in which system the applicator comprises a plurality of cartridges for accommodating the respective coloring preparations. These coloring preparations can be completely different such that a multi-tonal hair color result can also be achieved. Each of the cartridges also has a corresponding product discharge opening through which the hair coloring preparation is applied to the hair strand to be treated. However, the application system in the aforementioned document is only suitable for coloring preparations that have a very low viscosity and also only for compositions that are stable during long periods of storage. In the case of coloring hair treatment compositions, this is true, at best, of short-lasting hair toning preparations. Long-lasting, in particular reactive, hair coloring preparations cannot be used in connection with an applicator of this kind.

### BRIEF SUMMARY OF THE INVENTION

Proceeding herefrom, the object of the invention is to provide a hair treatment product which comprises a plurality of hair coloring preparations and makes multi-tonal hair color treatment readily possible. Moreover, a further object of the invention is to provide a method for applying a generic hair treatment product that can be carried out in an uncomplicated manner and is flexible in terms of the use thereof

The object is achieved by a hair treatment product as set forth herein, comprising a plurality of hair coloring preparations to be applied to the hair. The hair treatment product comprises a tray for accommodating a plurality of hair coloring preparations, wherein the tray comprises at least two cavities which are separated from one another by means of a partition in order for one hair coloring preparation to be held in each cavity for application.

Within the meaning of the invention, a “tray” is understood to be a shaped portion that is substantially uniformly planar and has, at least on one face, an arrangement of a plurality of adjacent compartment-like cavities for accommodating the individual hair coloring preparations. The tray according to the invention is therefore in some way comparable to a color palette, as is also used by artists.

In this connection, within the meaning of the invention, a hair coloring preparation is understood to be any composition for changing hair color. In this respect, the use of a plurality of different hair coloring preparations makes it possible to achieve multi-tonal hair coloring results. Hair coloring, hair bleaching and hair toning preparations in particular are used as suitable compositions for changing hair color, including, inter alia, semi-permanent compositions or combinations of semi-permanent and permanent compositions above all for applying bleach.

According to an advantageous embodiment of the hair treatment product, the tray has at least two cavities in each of two opposite faces. In order to increase flexibility, the number of cavities in the opposite tray faces is different; in particular, the tray has two cavities in one face and three cavities in the opposite face. In this way, the tray can accommodate either two or three hair coloring preparations in the respective cavities, depending on the application.

In order to make it easier to operate the hair treatment product, the tray comprises at least one fastening element for accommodating an identification marker for the hair coloring preparations accommodated in the cavities. The tray preferably has exactly the same number of fastening elements as cavities, such that the hair coloring preparations in all of the cavities can be labelled accordingly. Said marker is usually a card-like identification marker which can be pushed into the tray in each case through lateral slots or comparable fastening elements. Similarly, clip-like or clasp-like fastening elements can also be used.

Moreover, the individual trays are designed such that they can be stacked one on top of the other. For this purpose, each tray has corresponding projections and depressions on the upper face and lower face thereof. These projections and depressions fit into one another such that a plurality of trays can be stacked one on top of the other without difficulty. This also makes it easier to handle the trays.

A further expedient embodiment of the hair treatment product is achieved by each cavity having a minimum capacity of approximately 100 ml. In this way, an amount of hair coloring preparation that is sufficient for application can be accommodated in the cavity.

In a developed variant of the hair treatment product, each cavity has a substantially rectangular base surface. It has been found to be particularly advantageous in terms of application for the cavity to have this design. Furthermore, the lateral boundaries of each cavity are preferably rounded in order to thereby make it easier to clean the cavities after the tray has been used.

An expedient embodiment of the hair treatment product is achieved by said product comprising, in addition to the tray, an application element for absorbing at least two hair coloring preparations and applying them to the hair. In this case, the application element, in cooperation with the tray, is used to transport the hair coloring preparations from the tray to the hair. The application element preferably has a sponge-like application surface, such that it can particularly effectively absorb hair coloring preparation, intermediately store said preparation and subsequently apply said preparation to the hair region to be treated. In particular, the entire application element is designed as a sponge. Furthermore, the application surface is advantageously profiled, in order to thereby increase the absorbability of the application element and to improve handling when the hair coloring preparation is being applied. In principle, the application surface is preferably continuous and is therefore not divided into a plurality of segments that are separated from one another. This offers the significant advantage of it being possible for the different hair coloring preparations that are absorbed by the application surface to blend slightly into one another or to mix with one another slightly at the borders between the individual segments. In terms of the coloring result on the hair, this results in there being a seamless color transition between the individual tones that are used and there not being an undesirable abrupt change in color from one tone to the next. This corresponds exactly to the desired coloring result and also resembles the natural variation in shade of the untreated hair as closely as possible.

In a further embodiment of the hair treatment product, the application surface is adapted to the total surface area of the corresponding cavity base surfaces. This also means that the application surface is substantially rectangular. In this case, the surface area of the application surface corresponds at most to the total surface area of the cavity base surfaces. The total surface area of the application surface is preferably in a range of between 20 and 150 cm², particularly preferably in a range of from 50 to 100 cm². This provides for sufficiently precise coloring treatment of the selected hair strand and makes it possible for the application element to be held in just one hand in a very user-friendly manner.

An advantageous variant of the hair treatment product comprises an application element that has an ergonomic shape, which makes it possible for the application element to be held easily in just one hand. For this purpose, the application element also optionally has recessed handles or other suitable gripping portions at the sides.

According to a developed variant of the hair treatment product, it also optionally comprises at least one sheet as a backing layer for the hair strand to be treated. In this case, when the hair treatment product is being applied, the sheet is put underneath the separated hair strand that is intended to be treated. Owing to the sheet put underneath the hair, the hair coloring preparation can, above all, be applied to the hair strand in a significantly more precise manner, without there being the risk of hair regions that are not to be treated being unintentionally contaminated with hair coloring preparation. Depending on the application, the sheet can preferably be a paper or foil sheet.

Moreover, an associated method for hair treatment using an above-described hair treatment product according to the invention that comprises a tray and an application element is also under protection. According to this method, a plurality of different hair coloring preparations are first prepared for subsequently being applied to the hair. These hair coloring preparations can be mixed and provided in particular as mixtures consisting of a plurality of individual substances. The individual cavities in the tray are then filled with the different previously prepared hair coloring preparations. This can be optionally carried out using tools such as spatulas, brushes, or the like. The application surface of the application element is then wetted with the plurality of hair coloring preparations by pressing the application element into the cavities, the application surface being provided with the different hair coloring preparations such that they are one next to the other. For this, it is useful if the hair coloring preparations have a specific minimum viscosity, which prevents the individual hair coloring preparations from mixing with one another to too high a degree. Ideally, the viscosity of the individual hair coloring preparations is in this case in a range of from 100 to 100,000 mPas (determined using a Brookfield viscometer at 20° C. and 20 revolutions/minute). Subsequently, the hair strand to be treated is separated from the remaining hair and optionally put onto the at least one sheet. At this stage, the plurality of hair coloring preparations can be applied to the hair strand simultaneously in one go by means of the application element. In this case, the hair coloring preparations are actually applied to the hair strand by means of a movement oriented from the hair root towards the hair end. Once the hair coloring preparations have been left on the hair strand for the required action time of approximately 5 to 60 minutes, the backing sheet is first detached from the hair strand and excess hair coloring preparation is subsequently washed out of the hair. The hair treatment method according to the invention can optionally also include suitable, in particular hair care, post-treatment steps. In principle, the use of the backing sheet is not obligatory in the context of the application method. In some circumstances, omitting the sheet(s) simplifies application and reduces material costs. However, the optional use of one or more sheets makes it possible to color hair in a more precise manner and effectively prevents portions of hair that are not provided for coloring treatment from being unintentionally colored.

The tray comprising the cavities that are rounded at the bordering edges can be cleaned without difficulty following hair treatment and is thus suitable for multiple use. For storage purposes, a plurality of trays can be stacked one on top of the other, as mentioned previously, and are therefore advantageously stored in a space-saving manner.

In principle, the hair treatment product according to the invention and the associated application method for multi-tonal hair coloring are suitable, above all, for professional use at hair salons. Finally, the product and method are however flexible enough in terms of the use thereof that it is also conceivable for them to be used by the user themselves during home application.

### BRIEF DESCRIPTION OF THE DRAWINGS

Further features of the invention are also explained in the following with reference to the embodiment shown in the drawings, in which:

FIG. 1 is a perspective view of a tray upper face,

FIG. 2 is a perspective view of a tray lower face,

FIG. 3 is a side view of a stack of several trays,

FIGS. 4a and 4b show two views of a sponge-like application element,

FIG. 5 shows the application element and the tray during use, and

FIG. 6 shows the hair treatment method.

### DETAILED DESCRIPTION OF THE INVENTION

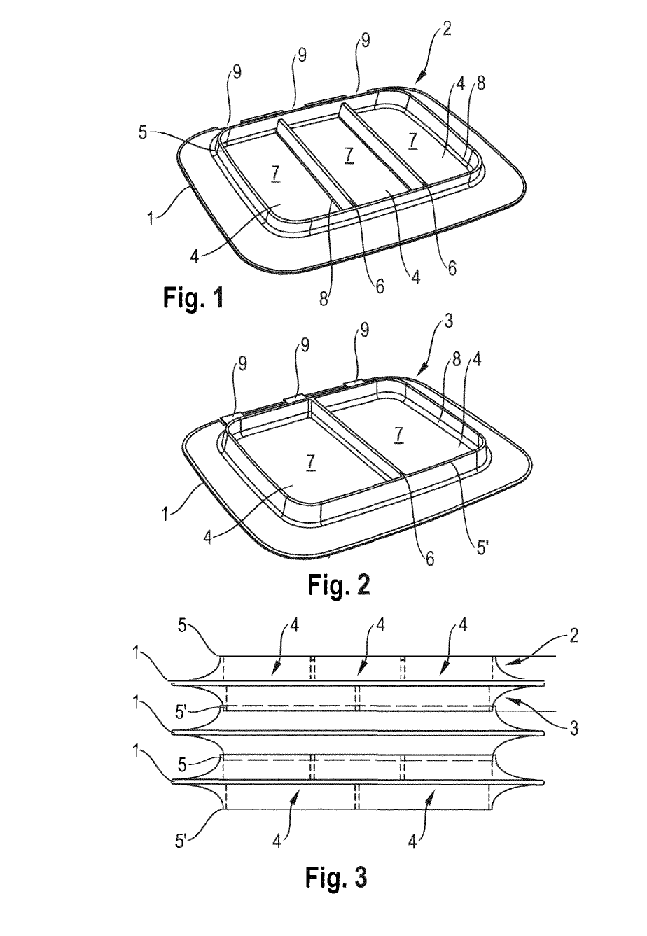

The embodiment shown in FIGS. 1-3 of a tray 1 according to the invention for hair coloring treatment comprises cavities 4 for accommodating the hair coloring preparations 21, 22, 23 in both the upper face 2 and the lower face 3. In this embodiment, the individual cavities 4 are separated from one another by an outer rim 5, 5′ and a partition 6. Therefore, the cavities are designed as compartment-like depressions in the tray 1. Each of the cavities 4 has a substantially rectangular basic shape, and therefore the base surface 7 of each cavity 4 also substantially forms a rectangle. This basic shape has been found to be extremely expedient for the hair treatment application. Furthermore, each of the cavities has a minimum capacity of 100 ml in order for it to be thereby possible for the amount of hair coloring preparation 21, 22, 23 required for application to be accommodated. Each cavity 4 is slightly rounded at the boundaries or edges 8 thereof so as to make cleaning the cavities 4 easier following hair treatment.

Furthermore, the tray 1 has, at the side thereof, preferably slit-like or clasp-like fastening elements 9 which accommodate identification markers for the hair coloring preparations 21, 22, 23. In this case, exactly the same number of fastening elements 9 are provided as cavities 4 in order for it to be possible to accordingly label all of the accommodated hair coloring preparations 21, 22, 23. The identification markers (not shown) of the hair coloring preparations 21, 22, 23 are preferably card-like and display distinct identification markers for the respective hair coloring preparations 21, 22, 23.

As can be seen in FIGS. 1-3, the tray has three cavities 4 in its upper face 2 and has two cavities 4 in its lower face 3. This cavity arrangement makes it possible for the tray 1 to be flexible in terms of the use thereof in the context of various hair coloring treatments.

FIG. 3 shows that a plurality of trays 1 can be stored in a very space-saving manner such that they are stacked one on top of the other. For this purpose, the rims 5, 5′ on the upper face 2 and the lower face 3 are designed such that they interlockingly fit into one another and therefore ensure that the plurality of trays 1 are stacked in a secure manner.

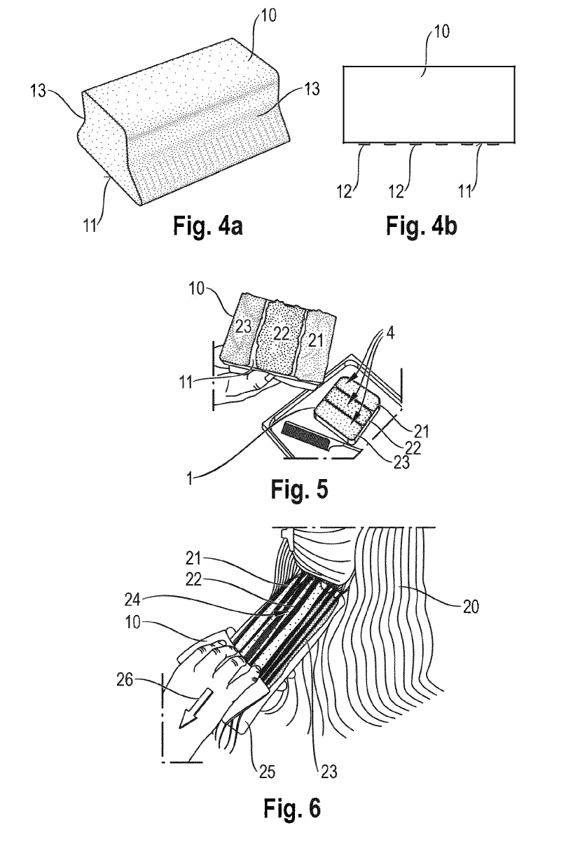

FIGS. 4a and 4b are two views of a sponge-like application element 10 which is provided to absorb the hair coloring preparations 21, 22, 23 and to apply said preparations to the hair strand to be treated. For this purpose, the application element 10 has an application surface 11 which can be wetted with the hair coloring preparations 21, 22, 23. At least on the application surface 11, the application element 10 preferably consists of a sponge-like material, as a result of which the application element is very capable of absorbing the hair coloring preparations 21, 22, 23. Furthermore, the application surface 11 is profiled; specifically, ribs 12 that project from the application surface 11 are formed. These ribs 12 are preferably oriented in the main application direction of the application element 10 and make it easier for the hair coloring preparations 21, 22, 23 to be both absorbed and applied.

The embodiment of the application element 10 from FIGS. 4a-6 is entirely in the form of a sponge. In this case, the application element 10 is also ergonomically shaped and is thus designed to be used in a user-friendly manner in just one hand. For this purpose, the application element 10 also has recessed handles 13 or gripping portions having a similar effect at the sides thereof. A sponge-like application element 10 of this kind can be used by any user using just one hand irrespective of hand size, not least because of it being elastically deformable.

In principle, the size of the application element 10 and of the application surface 11 thereof can be adapted to the total surface area of all the cavities 4 in the tray 1. Specifically, the application surface 11 is only slightly smaller than the total surface area of the corresponding cavity base surfaces 7 in the tray 1. Furthermore, the application surface 11 is also substantially rectangular. As a result of this adaptation, application is simplified and an optimum amount of hair coloring preparations 21, 22, 23 can be absorbed by the application element 10.

FIGS. 5-6 show the corresponding method according to the invention for applying the above-described hair treatment product. In principle, the hair treatment method is used for multi-tonal hair color treatment in order to simultaneously provide the portions of hair to be treated with a plurality of tones in one step. For this purpose, the cavities 4 in the tray 1 are first filled with various hair coloring preparations 21, 22, 23. In the present embodiment, the three cavities 4 in the tray upper face 2 are filled with three different hair coloring preparations 21, 22, 23. In this case, the individual hair coloring preparations 21, 22, 23 can also be thoroughly premixed from individual substances. The individual hair coloring preparations 21, 22, 23 preferably have a specific minimum viscosity, which significantly simplifies operation. The associated sponge-like application element 10 is then pressed into the filled cavities 4, as a result of which the application surface 11 of which element is wetted with the three hair coloring preparations 21, 22, 23. Specifically, there are three regions on the application surface that comprise the three hair coloring preparations 21, 22, 23.

FIG. 6 shows the actual application of the hair coloring preparations 21, 22, 23 onto the hair strand 24 to be treated. For this purpose, the hair strand 24 to be treated is first separated from the remaining hair 20 and put onto a backing sheet 25. The backing sheet 25 prevents portions of hair that are not to be treated from being contaminated with hair coloring preparations 21, 22, 23 and simplifies application of the hair coloring preparations 21, 22, 23 onto the hair strand 24. The backing sheet is specifically a paper or foil sheet, depending on the application. The main application direction 26 of the hair coloring preparations 21, 22, 23 and thus the main movement direction 26 of the application element 10 extends in this case from the hair root as far as the hair end and thus covers the entire hair length. As a result of three hair coloring preparations 21, 22, 23 being applied to the hair strand 24 simultaneously, the hair coloring treatment can be carried out very quickly.

Once the hair coloring preparations 21, 22, 23 have been left on the hair strand 24 for a sufficient action time, the backing sheet 25 is detached and excess hair coloring preparation 21, 22, 23 is washed out of the hair.

Both the sponge-like application element 10 and the tray 1 are fundamentally suitable for being reused. The application element 10 and the tray 1 can be cleaned without difficulty following successful hair treatment and thereby prepared for the next hair treatment.

In principle, the hair treatment method according to the invention is equally usable in connection with hair coloring, hair bleaching and hair toning products. In this case, the hair treatment method is predominantly used in the field of professional hair treatment, i.e. in hair salons. However, the design of the hair treatment product and of the associated application method are universally usable such that it is also conceivable for them to be used by the user themselves during home application.

### LIST OF REFERENCE SIGNS

1. tray
2. tray upper face
3. tray lower face
4. cavity
5. rim
6. partition
7. base surface
8. cavity edge
9. fastening element
10. application element
11. application surface
12. ribs
13. handles
20. hair
21. hair coloring preparation 1
22. hair coloring preparation 2
23. hair coloring preparation 3
24. hair strand
25. sheet
26. main application direction

What is claimed is:

1. A hair treatment product comprising a plurality of hair coloring preparations for being applied to the hair, and comprising a tray for accommodating a plurality of hair coloring preparations, wherein the tray comprises at least two cavities which are separated from one another by means of a partition in order for one hair coloring preparation to be held in each cavity for application.

2. The hair treatment product according to claim 1, characterized in that the tray has at least two cavities in each of two opposite faces.

3. The hair treatment product according to claim 2, characterized in that the tray has two cavities in one face and three cavities in the opposite face.

4. The hair treatment product according to claim 1, characterized in that the tray comprises at least one fastening element for accommodating an identification marker for the hair coloring preparations accommodated in the cavities.

5. The hair treatment product according to claim 1, characterized in that each cavity has a minimum capacity of approximately 100 ml.

6. The hair treatment product according to claim 1, characterized in that each cavity has a substantially rectangular base surface.

7. The hair treatment product according to claim 1, characterized in that it also comprises an application element for absorbing at least two hair coloring preparations and applying said preparations to the hair.

8. The hair treatment product according to claim 7, characterized in that the application element has a sponge-like application surface.

9. The hair treatment product according to claim 8, characterized in that the application surface is profiled.

10. The hair treatment product according to claim 7, characterized in that the application surface is adapted to the total surface area of the corresponding cavity base surfaces.

11. The hair treatment product according to claim 7, characterized in that the application element is ergonomically shaped, and this makes it easier for said element to be held in one hand.

12. The hair treatment product according to claim 1, characterized in that it also comprises at least one sheet as a backing layer for the hair strand to be treated.

13. A method for treating hair using the hair treatment product according to claim 1, characterized by the following method steps:
creating a plurality of different hair coloring preparations for being applied to the hair,
filling the individual cavities in the tray with the different hair coloring preparations,
wetting the application element with the plurality of hair coloring preparations by pressing the application element into the cavities,
separating the hair strand to be treated,
applying the plurality of hair coloring preparations to the hair strand by means of the application element,
leaving the hair coloring preparations to act on the hair strand,
washing the excess hair coloring preparation out of the hair.

14. The method for treating hair using the hair treatment product according to claim 1, characterized by the following method steps:
creating a plurality of different hair coloring preparations for being applied to the hair,
filling the individual cavities in the tray with the different hair coloring preparations,
wetting the application element with the plurality of hair coloring preparations by pressing the application element into the cavities,
separating the hair strand to be treated, and putting the hair strand onto the at least one sheet,
applying the plurality of hair coloring preparations to the hair strand by means of the application element,
leaving the hair coloring preparations to act on the hair strand,
detaching the sheet from the hair strand,
washing the excess hair coloring preparation out of the hair.
